(19) United States
(12) Patent Application Publication
(10) Pub. No.: US 2019/0392527 A1
(43) Pub. Date: Dec. 26, 2019

(54) SYSTEM AND METHOD FOR ADMINISTERING A LIFE INSURANCE POLICY

(71) Applicant: Mark J. Smith, Mound, MN (US)

(72) Inventor: Mark J. Smith, Mound, MN (US)

(21) Appl. No.: 16/452,678

(22) Filed: Jun. 26, 2019

Related U.S. Application Data
(60) Provisional application No. 62/689,931, filed on Jun. 26, 2018.

(51) Int. Cl. G06Q 40/08

(52) U.S. Cl. CPC G06Q 40/08

(57) ABSTRACT

A software method to effectuate value enhancement riders that attach to indexed universal life insurance policies. The system enables the policy to substantially expand the policies notional values exposed to market volatility. The enhancement rider(s) come in three forms: a premium based enhancement rider, an accumulated value based enhancement rider and a combination of the two riders. Policy owners can opt in and opt out of the rider(s) annually. The software system nests insider a carrier's home office policy administration system and performs all the operational and maintenance functions that the rider(s) requires to function properly. Importantly these rider(s) dramatically affect the operating parameters of the policy. These rider(s) change the mundane accumulation performance associated with that of typical indexed life insurance policy into the financial industry's leading source of cash accumulation.

### CROSS REFERENCE TO RELATED APPLICATIONS

This U.S. Utility patent application claims priority to U.S. Provisional Patent Application No. 62/689,931 filed Jun. 26, 2018 titled: System And Method For Administering A Life Insurance Policy, which is fully incorporated by reference herein.

### FIELD OF THE DISCLOSURE

This disclosure relates to insurance. More specifically and without limitation, this disclosure relates to a method of administering a life insurance policy harnessing the power of notional value.

### BACKGROUND OF THE DISCLOSURE

There are countless forms of life insurance policies. In general, life insurance policies are financial instruments that are intended to provide financial benefits in the event of death or incapacity of the policy holder. To promote the use of life insurance policies and to facilitate their noble purposes, various tax-related benefits have been bestowed upon life insurance policies to allow capital to grow without being taxed. However, a great number of regulations and restrictions have also been bestowed upon life insurance policies which restrict and limit the ways in which life insurance policies may operate. These restrictions, while also noble in purpose, have had the effect of severely limiting the potential returns a policy holder may expect from a life insurance policy. These restrictions have unnecessarily applied the brakes to potential returns for life insurance policies making life insurance policies less attractive than other investment and wealth-management tools.

As such, the regulatory framework has established a tension between investments or securities, which are governed by the Securities Act of 1933, and certain life insurance products which qualify for an exemption under Section 3(a)(8) of the Securities Act of 1933. Securities provide a great amount of flexibility as it applies to investment options; however they suffer a great amount of tax penalties. Life insurance policies provide a great amount of tax benefits; however they suffer from being strictly limited as it applies to investment options. This results in either electing flexibility with increased potential returns and higher taxation through securities, or electing substantial tax benefits with sub-optimal returns and limited options through life insurance.

In view of this framework, there is a need in the industry to provide a life insurance policy and manner of administering a life insurance policy that harnesses the tax benefits afforded to life insurance policies while providing the policy holder with flexibility within the policy to harness returns based on market performance while still qualifying for a life insurance policy exemption under Section 3(a)(8) of the Securities Act of 1933

Thus, it is a primary object of the disclosure to provide a method of administering a life insurance policy that improves upon the state of the art.

Another object of the disclosure is to provide a method of administering a life insurance policy that improves the accumulation value performance of a life insurance policy over existing life insurance policies.

Yet another object of the disclosure is to provide a method of administering a life insurance policy that allows a policy owner to better manage the performance attributes of the policies accumulation values.

Another object of the disclosure is to provide a method of administering a life insurance policy that allows a policy owner to capitalize on expanded exposure to financial derivatives.

Yet another object of the disclosure is to provide a method of administering a life insurance policy that provides some of the benefits of expanded market performance while not exposing the returns to tax liabilities associated with investment accounts.

Another object of the disclosure is to provide a method of administering a life insurance policy that maintains the benefits of being an insurance policy while harnessing derivative style returns.

Yet another object of the disclosure is to provide a method of administering a life insurance policy that provides the policy owner with the option to purchase a premium based enhancement rider.

Another object of the disclosure is to provide a method of administering a life insurance policy that provides the policy owner with the option to purchase an accumulation value based rider.

Yet another object of the disclosure is to provide a method of administering a life insurance policy that provides the policy owner with the option to purchase a premium based enhancement rider as well as an accumulation value rider(s).

Another object of the disclosure is to provide a method of administering a life insurance policy that is relatively easy for the life insurance company to administer.

Yet another object of the disclosure is to provide a method of administering a life insurance policy that does not run afoul of life insurance industry regulations, rules and laws. Another object of the disclosure is to provide a method of administering a life insurance policy that does not run afoul of securities industry regulations, rules and laws.

Yet another object of the disclosure is to provide a method of administering a life insurance policy that provides dramatically better performance over existing life insurance policies.

Yet another object of the disclosure is to provide a method of administering a life insurance policy that provides increases viability outcomes through greater exposure to market volatility through an insurance instrument.

Another object of the disclosure is to provide a method of administering a life insurance policy that is relatively easy for the policy owner to comprehend and control.

Yet another object of the disclosure is to provide a method of administering a life insurance policy that operates efficiently.

Another object of the disclosure is to provide a method of administering a life insurance policy that complies with the spirit and scope of insurance laws.

Yet another object of the disclosure is to provide a method of administering a life insurance policy that complies with the spirit and scope of securities laws.

Another object of the disclosure is to provide a method of administering a life insurance policy that provides policy owners with an increased probability or viablity of positive outcomes.

Yet another object of the disclosure is to provide a method of administering a life insurance policy that provides new avenues for wealth accumulation and wealth preservation.

Another object of the disclosure is to provide a method of administering a life insurance policy that can provide the policy owner with enhanced policy guarantees.

These and countless other objects, features, or advantages of the disclosure will become apparent from the specification, claims and drawings.

### SUMMARY OF THE DISCLOSURE

A method of administering policy rider(s) attached to index universal life insurance policies (IUL). Traditionally, index life insurance policies performance is driven solely through internal or core policy dynamics. The technology being introduced enables an insurance company the method to internally bifurcate aspects of the policy as a means to manage a policies' applicable notional value. Importantly, ‘notional value’ is not a term typically used in the context of a life insurance policy as it is more common to the derivatives industry. Notional value describes the ‘total value of a trade’ or ‘what value is actually exposed to market volatility’. Indexed Universal Life Insurance policies possess values being exposed to market volatility but there is no common insurance industry term used to articulate the exact value or “notional value” exposed to market volatility. The technology presented herein is encapsulated in the software code required for an insurance company to properly demonstrate, illustrate, administer, and otherwise facilitate a series of optional life insurance policy riders that will be attached to indexed universal life insurance policies. This rider technology effectively allows for policies to attain multiple additional sources as a means to expand the notional value (‘what value is actually exposed to market volatility’) under a single policy. These additional notional value sources will come about through a premium based enhancement rider, an accumulation value based enhancement rider as well as a combination of a premium based enhancement rider, an accumulation value based enhancement rider. Policyholders will be able to voluntarily opt into and to opt out of these rider(s) annually. This technology effectively unites the policy owners' ability to increase (or decrease) a policies' notional value, with the most efficient method of attaining market exposure (derivatives) and the most tax efficient means of capturing investment returns (cash value life insurance). Operationally these riders implemented through the software program articulated and come as an additional (optional) cost to the policy owner. The software that runs the system presented herein establishes the cost of the rider(s) based on a pre-established percentage factor, it applies that cost factor to cost streams of the policy at the predefined position, it exacts that applicable cost from the policy, it then attains a market unit price (via a derivatives desk) for the specified underlying market exposure, it calculates the rider(s) notional value exposure given derivative unit cost with the rider costs extracted from the policy. The rider software then secures the appropriate derivative coverage and tracts the market price/performance through to the fruition of the contract. The software reconciles the theoretical performance with the actual derivative monies collected to insure the policy is functioning as promised. Generally speaking life insurance policies have dynamic pricing structures in that pricing relies on performance, a policies' ongoing pricing is continually amended to reflect the underlying actual performance and the rider control system is also dynamic in nature. This method of administering a life insurance policy maintains the exemption under Section 3(a)(8) of the Securities Act of 1933 while providing the policy holder with a great amount of flexibility as to how much risk, and how much potential reward, the policy holder wants to elicit through performance rider enhancement rider strategies. This arrangement will provide substantially higher potential returns while maintaining tax preferred status.

### BRIEF DESCRIPTION OF THE DRAWINGS

FIG. 1 is a demonstrative example plan view of a policy owner performance enhancement rider's dashboard, through which a policy owner can initiate policy performance enhancement riders; the view showing an option to elect into performance enhancement riders; the view showing the option to elect into a premium enhancement rider along with an option to elect the percentage of the premium to be allocated to the premium enhancement rider; the view showing the option to elect into an accumulated value enhancement rider along with an option to elect the percentage of the accumulated policy value to be allocated to the accumulated value enhancement rider.

FIG. 2 is a demonstrative example plan view of a diagram of an indexed universal life insurance Policy Calculation Sequencing algorithm based on the policy owner input selections from FIG. 1, the view showing.

FIG. 3 is the Premium Enhancement Rider Cost Input Calculation Process it diagrams the monthly policy calculation process required to establish monthly rider cost inputs.

FIG. 4 is the Accumulation Value Enhancement Rider Cost Input Calculation Process it diagrams the monthly policy calculation process necessary to establish monthly cost inputs.

FIG. 5 is the Policy Calculation Process diagram. This diagram provides the backbone for running policy operations. The process integrates data from external sources and processes as well as exchanges data streams with other sources.

FIG. 6 is the Cost of Insurance Calculation Process diagram. It calculates a policies cost of insurance through an iterative process. This process interacts with FIG. 3, FIG. 4 and FIG. 5.

FIG. 7 is the Policy Index Crediting Process diagram. This process receives data from external calculates data and sends it through policy crediting operations. This process interacts with FIG. 3, FIG. 4 and FIG. 5.

FIG. 8 this diagram illustrates the Entity Interactions of the process required to run the policy performance enhancement riders.

FIG. 9 Exhibit A demonstrates the embodiment of a of an Indexed policy without the policy enhancement riders. This exhibit is a close relation to illustrations used by industry to demonstrate prospective policy performance. This exhibit is based on fixed crediting and pricing assumptions.

FIG. 10 Exhibit B demonstrates the embodiment of a of an Indexed policy with the inclusion of the Premium Performance Enhancement Rider. This exhibit is a close relation to illustrations used by industry to demonstrate prospective policy performance. This exhibit is based on fixed crediting and pricing assumptions.

FIG. 11 Exhibit C demonstrates the embodiment of a of an Indexed policy with the inclusion of the Accumulated Value Performance Enhancement Rider. This exhibit is a close relation to illustrations used by industry to demonstrate prospective policy performance. This exhibit is based on fixed crediting and pricing assumptions.

FIG. 12 Exhibit D demonstrates the embodiment of a of an Indexed policy with the inclusion of both the Premium Performance Enhancement Rider plus the Accumulated Value Performance Enhancement Rider. This exhibit is a close relation to illustrations used by industry to demonstrate prospective policy performance. This exhibit is based on fixed crediting and pricing assumptions.

FIG. 13 Exhibit E demonstrates the embodiment of a of an Indexed policy without the policy enhancement riders. This exhibit is a close relation to illustrations used by industry to demonstrate prospective policy performance. This exhibit is based on single iteration of a stochastic Monte Carlo simulation based on random crediting and pricing assumptions.

FIG. 14 Exhibit F demonstrates the embodiment of a of an Indexed policy with the inclusion of the Premium Performance Enhancement Rider. This exhibit is a close relation to illustrations used by industry to demonstrate prospective policy performance. This exhibit is based on single iteration of a stochastic Monte Carlo simulation based on random crediting and pricing assumptions.

FIG. 15 Exhibit G demonstrates the embodiment of a of an Indexed policy with the inclusion of the Accumulated Value Performance Enhancement Rider. This exhibit is a close relation to illustrations used by industry to demonstrate prospective policy performance. This exhibit is based on single iteration of a stochastic Monte Carlo simulation based on random crediting and pricing assumptions.

FIG. 16 Exhibit H demonstrates the embodiment of a of an Indexed policy with the inclusion of both the Premium Performance Enhancement Rider plus the Accumulated Value Performance Enhancement Rider. This exhibit is a close relation to illustrations used by industry to demonstrate prospective policy performance. This exhibit is based on single iteration of a stochastic Monte Carlo simulation based on random crediting and pricing assumptions.

### DETAILED DESCRIPTION OF THE DISCLOSURE

In the following detailed description, reference is made to the accompanying drawings which form a part hereof, and in which is shown by way of illustration specific embodiments in which the disclosure may be practiced. These embodiments are described in sufficient detail to enable those skilled in the art to practice the disclosure, and it is to be understood that other embodiments may be utilized and that mechanical, procedural, and other changes may be made without departing from the spirit and scope of the disclosure (s). The following detailed description is, therefore, not to be taken in a limiting sense, and the scope of the disclosure (s) is defined only by the appended claims, along with the full scope of equivalents to which such claims are entitled.

Introduction:

This disclosure pertains to a system and methodology for the administration of an optional policy rider system which can be attached to Indexed Universal Life Insurance policies. This technology establishes the systematic means to manipulate a policy's overall notional value. This technology calculates the cost of the rider(s) in an iterative environment given the dynamic nature of policy pricing. This technology incorporates fluctuating market input prices into its rider policy pricing scheme. This technology establishes the revised notional values applicable for both the base policy and to the rider(s) which may include a premium based enhancement rider and/or an accumulated value rider, or any other rider or combination thereof. This technology reconciles the cost(s) of the rider(s) with the rider(s) notional value(s) for the initiation/purchase of additional derivative cover. This technology tracks the performance of the underlying market based derivative (for both the base policy and the rider(s)). This technology calculates the payoff valuation of the rider(s) at the expiration of the underlying derivative employed. This technology provides to the insurance carrier's policy administration system all the inputs and outputs of its calculation algorithm. This technology interfaces with the carrier's administration system on an iterative and/or continuous basis.

This technology is also applicable (via a separate admin system or inclusive of main policy administration system) to the carrier's marketing and sales illustration methods. This technology supplies the basis of demonstration for the general public looking to possibly elect the rider(s) to comprehend the cost(s) and performance attributes of the rider(s).

This technology can be incorporated in such a manner as to allow the supporting carrier to extend to policy owners a cumulative net premium crediting rate guarantee.

This technology when incorporated into an Indexed Universal Life Insurance policy system dramatically transforms the performance dynamics of life insurance industrywide, will significantly alter the internal policy returns of Indexed Universal Life Insurance, will provide policyholders transformational viability/probability statistics, will provide the insurance industry (as well as the greater financial services industry) with a new ‘best of breed’ tool for the funding of future financial liability needs for policyholders—these financial liabilities would include, but are not limited to: future income needs, death benefit needs, long-term care needs as well as disability needs.

Background of the Insurance Industry:

Life insurance companies have several distinct attributes in regard to their regulatory environment, operating structure as well as the taxation afforded to the policies they manufacture and sell to the public.

Certain life insurance products have enjoyed a regulatory exemption from the Securities Act 1933 through the Section 3(a)(8) exemption. Insurance products meeting the criteria of Section 3(a)(8) of the Securities Act of 1933 have been deemed to be insurance products rather than securities (despite the fact that they have many attributes that appear to be security-like in nature, such as having some market exposure). In particular, three primary varied interest rate crediting models have been deemed excluded: a.) excess interest rates, b.) interest rate based on market value adjustment, and c.) interest rates tied to limited stock index or bond index performance. These crediting rate strategies have been incorporated into both annuity and life insurance product designs over the decades. The significance of being deemed insurance products as opposed to securities has far reaching consequences that go beyond the scope of this primer. But consequential to this discussion, Indexed Universal Life products allow policyholders to gain limited market index upside performance while retaining the sheltered downside characteristics of fixed (General Account) insurance products (e.g. guaranteed minimum returns, death benefits). These Section 3(a)(8) insurance products are regulated by individual state insurance commissions.

Investments on the other hand are variable products (securities) governed by the Securities Act of 1933. Sales of securities require specific licensure and oversight is conducted by Financial Industry Regulatory Authority, Inc. an industry self-regulatory organization.

Insurance companies have a unique operating structure when it comes to non-securities or General Account business. This structure is highly notably but not commonly well understood. That is, insurance policies (non-securities) are basically promises to pay benefits in exchange for the premiums charged and collected. Carriers generally do not set-aside specific funds to cover specific policies. Rather they extend promises and in some cases even guarantees to pay stated benefits based on a triggering event(s) (i.e. death, long-term incapacity, disability etc.) and they execute a contract (i.e. policy) to memorialize the respective duties/guarantees and promises between the insurer and the policy owner. Monies collected by the carrier for general account products/liabilities are held and invested within the carrier's General Account. The account established for the benefit of all policy owners collectively. The General Account is however subject to a company's claims of creditors of the carrier. The aggregation of assets into the General Account employed to support promised benefits collectively affords a degree of macro efficiency unique to insurers. (That is, carriers collect micro amounts of monies from policy owners in return for promises to pay, the carriers then lump micro amounts of monies in the General Account which is managed in a macro manner thereby harnessing the benefits of economies of scale and macro investment decision making). This operation lies in stark contrast to the investment industry which must hold assets/investments in separate accounts for the exclusive benefit of each individual investment owner. Separate accounts are both assets and corresponding liabilities and are not subject to the claims of creditors of the investment companies themselves.

Insurer's home office policy administration systems (“admin system”) calculate, coordinate and account for all aspects of policy operations. The admin system has a series of algorithms to coordinate the application of premiums, guarantees, loads, expenses and charges as well as policy credits. These home office admin systems are micro at the each individual policy level as well as macro encompassing the entire asset/liability position of the company. Additionally, where appropriate to a specific form of life insurance policy characteristics the carrier has specialized algorithms which govern policy crediting strategies based on formulaic calculations derived from external financial market inputs (indices)—these policy types are commonly referred to as Index Universal Life Insurance.

Accumulation value life insurance policies (which include Indexed Universal Life (IUL) insurance policies) generally are afforded unique rules of taxation assuming the policies are in conformance with common standards of industry practice. These taxation novelties include: tax free internal build-up of accumulation values, tax free death benefit, death benefit advances during the insureds lifetime (tax deferred) in the form of loans & withdrawals as well as tax free payment of all policy expenses (internal to the policy) via the accumulation value. Again, this is different than the taxation afforded non-qualified investment accounts which are taxed on a transactional basis. In summary, an Indexed Universal Life (IUL) insurance policy is not a security assuming it conforms with Section 3(a)(8) of the Securities Act of 1933. Premiums paid into an IUL policy less expenses (accumulation value) are held by the carriers General Account which is invested at a macro level. Calculations of policy values are based on algorithms, and not actual underling investments. Values and benefits attributed to each policy are actually a share of (or are backed up by) the carrier's General Account. Policy information (benefits, values, ownership, premiums etc.) are affectively journal entry's resident to the carrier's home office policy administration system. Assuming the policy is in conformance with industry norms, the policy owner can enjoy tremendous tax advantages. The securities industry has no corporate structure or product(s) which perform in a similar manner.

Current forms of permanent life insurance policy designs lack optimal accumulation value performance. This disclosure changes the dynamics of accumulation value performance. This disclosure creates a highly desirable cash accumulation vehicle. It incorporates all the best character traits of the insurance world while providing many of the best attributes of securities industry.

This disclosure improves upon the abysmal financial performance of existing life insurance policies in two ways: first it increases the notional value exposure of the policy, additionally it channels accumulation values directly toward (prospectively) higher yielding returns. Furthermore, it does all this while providing the policy owner the ability to control the amounts at play.

The system presented is an optional policy feature a policyholder can elect. It adds an additional charge to the policy expenses through the purchase of a rider. At least two riders are offered, a premium based enhancement rider, wherein a portion of the premium net of other expenses is allocated to the rider, and an accumulated value rider, wherein a portion of the net accumulated policy value is allocated to the rider. The rider charges are then collected and used to purchase financial derivatives (Options) on an Index, series of indices or formula of indices similar to the main policy. These riders effectively inflate the policies exposure (notional value) to the underlying index strategy. The use of the rider(s) results in a levering effect relating to index performance. In response, to knowing how much of the policies monies are employed through the riders, the life insurance company can cover that corresponding policy liability by purchasing additional derivatives coverage (i.e. financial options) or employ a self-determined internal hedging strategy within the General Account. This system allows a policy holder to elect exposure to options on a micro level that the policy holder would never otherwise have access to due to the minimal amount at play, then the carrier executes on the appropriate options strategy with macro efficiencies and macro amounts of money through the aggregation of multiple policy holders electing similar exposure. In this way, this system provides policy holders with access to financial instruments they would not otherwise be able to utilize. In addition, this system does so while providing substantial tax benefits.

Operation of the System:

Universal Life Insurance—A form of permanent life insurance (a.k.a. cash value) featuring a flexible premium architecture.

Indexed Universal Life—Basic universal life insurance with an additional feature that allows accumulation value performance to be pegged to a financial index, a series of indices or a formula of indices.

Insurance Premium—Established cost of insurance policy.

Policy Accumulation Value—Premiums (plus previous year's accumulation value) net of insurance policy costs and fees plus policy credit.

Net Policy Premiums—Premium (plus previous years accumulation value) less policy costs and expenses.

Net Amount at Risk (NAR)—A calculation developed to determine an insurance carrier's actual risk of financial loss in the event of a death of the insured. The calculation subtracts any cash values held in the policy from the death benefit promised the policy owner.

Notional Policy Value—(in addition to further description herein) A calculated value is used to determine underlying value exposed for policy crediting rate purposes. The notional value is the numerator that receives the market returns experienced.

Policy Administration System—An insurance company system that tracks obligations, benefits, payments and calculates individual policyholder values as well as overall aggregate insurance company liability exposures and promises.

Policy Calculation Algorithm—Governs the order and amount(s) of the various debits, charges, costs and credits to be applied to the policy, additionally it tracks and applies investment performance of both the General Account as well any external Financial Indexes employed by the policies. The Policy Calculation Algorithm is resident to the Policy Administration System.

Insurance Company General Account—An account and related investment fund used to guarantee/back/fulfill insurance company benefits/promises to policyholders. Typically, an insurer's General Account is vastly comprised of high quality fixed income investment instruments.

Options Budget—Is the sum of money a policy is afforded from the general account for the purchase of options. In the case of IUL policies this is the sum of money employed to finance the purchase of financial options (i.e. S&P 500 Index) pursuant to the underlying IUL strategy. Importantly, IUL policy owners have the choice to receive a stated crediting rate (typically associated with the General Account (Bond Yields)) or policy owners can swap that return for a market based return generated via a financial index or other securities instrument (which often also includes a guaranteed minimum return, capped maximum returns and an accompanying death benefit).

Derivative Desk—A provider of derivative investment instruments (options, futures, specialized investments, hedging). A derivative desk may be internal to the carrier or external to the carrier. The derivative desk may provide pricing for options, this pricing is then used to calculate the cost of options, which can be used to determine the pricing of the policy and the related policy returns, as well as other aspects of accounting related to the system presented herein.

Policy Value Calculation Algorithm—The systemic methodology (routine(s)) developed to update and calculate policyholder values.

The system presented herein is an optional rider(s) system attached to an Indexed Universal Life Insurance policy. It turns a rather mundane mal-performing financial instrument into potentially one of the best performing asset accrual instruments ever created. It is a life insurance performance enhancement mechanism which systemically manipulates a policies' notional value or notional derivative value. It effectively turns an Indexed Life Insurance policy into a derivative purchasing method. It takes form on a carrier's home office life insurance company policy administration system by way of a specialized algorithm.

The System Presented Herein Differs from Existing Technology:

Currently, life insurance carriers purveying permanent life insurance (cash value) policies have a rather common policy algorithm (functioning on their home office policy administration system) that generally takes into account premium inflows, deducts policy loads and monthly policy expenses to arrive at a Net Amount at Risk (NAR) it then charges the policy a cost of insurance for that particular time period (day, week, month, quarter, year, etc.). After the loads and charges are subtracted the remaining sum of monies in the policy are commonly referred to as the Net Premium. The net premium sum is then deposited into the carriers General Account to accrue interest. The next month, again more premium may be added as well as monthly expenses deducted, a new NAR is established to which cost of insurance rates are applied resulting in a slightly higher cost of insurance expense. This process is continually replicated throughout the duration of the policy. Often carriers average the Net Premium (or in some other similar manner calculates) the monies attributed to the policy deposited into the General Account over the course of the year to arrive at the Notional Policy Value. This Notional Value is used as a proxy to determine what sum would be the basis for earning interest crediting as well as to establish the interest earnings (Derivative or Options Budget) which could be swapped to receive interest credits derived via an outside financial index. Interest credits earned come in the form of General Account (interest rate/yield) return (Universal Life Policy and/or Indexed Universal Life) or in the case of an IUL policy the policyholder can elect to forgo a predetermined interest rate tied to the general account to obtain a return based on the return of a financial index, a series of indices or a formula of indices or the like. The exposure to the financial index is established through the purchase of a derivative contract which is supplied via a Derivative Desk (which may be an external entity or company, or it may be internal to the life insurance company). The yield or return off the General Account is used to finance the purchase of the derivatives. Effectively, the derivative is self-financed via a swap out of the policies share of interest off the carriers General Account.

The carrier's algorithm effectively provides for the policies' options budget and the policies' notional value. The derivative purchased in the case of an IUL policy conforms to those specifics.

The present policy design and corresponding algorithm operating the cash value segment of the life insurance industry functions as proscribed above. This design has effectively limited the policies' optimal accumulation value performance and in most cases will prove to be very disappointing to current policyholders.

So a new methodology is needed for people and entities to achieve optimal policy accumulation value. The Enhancement rider(s) and related algorithm(s) presented herein is that mechanism.

The premium based enhancement rider strategy presented herein is an elective policy attribute a policy owner can select (or not select). As one example, when selected, the cost of the premium based enhancement rider is a percentage of the net premium of the policy. As one example, the charge is based on a fixed percentage of the premium paid annually (or on any other term) net of expenses. The sums collected via rider charges are funneled toward the purchase or employment of additional derivative (i.e. financial options) coverage via a derivatives desk. Effectively the premium based enhancement rider increases the overall Notional Value of the policy. The Policy Calculation Algorithm is amended to accommodate the premium based enhancement rider—by doing so it calculates and applies the riders (fluctuating) cost structure, it calculates the additional notional value exposure obtained based the current unit price of the derivative, it then tracks the performance of the riders underlying financial index to determine the extent of the return applied to the policy.

The accumulation value based enhancement rider is an elective policy attribute a policy owner can select. The cost of the accumulation value based enhancement rider is a percentage of the net accumulation value of the policy. The charge mirrors the performance of the policies accumulated value over time. The sums collected via rider charges are funneled toward the purchase or employment of additional derivative (i.e. financial options) coverage via a derivatives desk. Effectively the accumulation value based enhancement rider increases the overall Notional Value of the policy. The Policy Calculation Algorithm is amended to accommodate the accumulation value based enhancement rider—by doing so it calculates and applies the riders (fluctuating) cost structure, it calculates the additional notional value exposure obtained based on the current unit price of the derivative, it then tracks the performance of the riders underlying financial index to determine the extent of the return applied to the policy.

Additionally a policy holder may elect both riders (premium+accumulation value). Electing both riders create a performance balance unattainable through just one of the riders.

The additional notional value exposure attained via the rider(s) changes the dynamics of indexed universal life insurance policy accumulation value performance. The rider strategies free the indexed universal life insurance policy structure from the General Account return limitations. Derivatives (Options) have very unique performance attributes. The unit cost is a factor often expressed as a percentage of notional value (i.e. 5%) and the payoff is also calculated based on the notional value employed. As a hypothetically, the Notional Value was $1,000,000 and the underlying derivative was based on the return of the S&P 500 Index which achieved a 10% return during the term of the policy. The enhancement rider result: the cost at 5% would be $50,000 and payoff of the derivative would be $100,000 an effective ROI of 100%.

As one example, with reference to the figures, a system and method for administering a life insurance policy 10 (or simply system 10) is presented. The system 10 includes a policy owner 12 and a life insurance company 14 that provides a life insurance policy 16 to the policy owner 12 in return for a premium 18, among other components and features described herein.

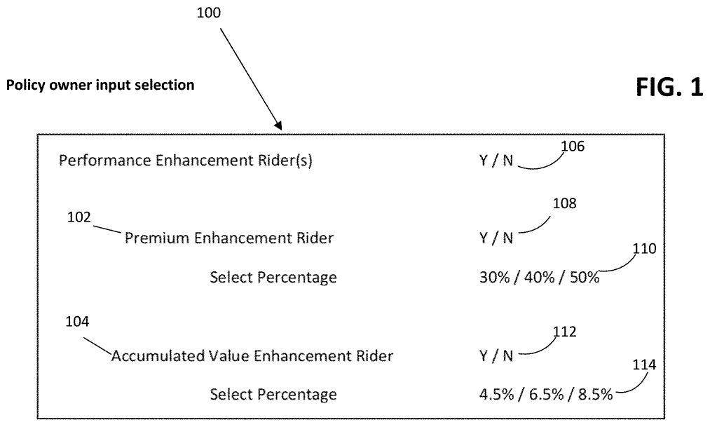

With reference to FIG. 1, in association with the establishment of the life insurance policy 16, the policy owner 12 is presented with a performance enhancement rider dashboard 100, through which a policy owner 12 can initiate policy performance enhancement riders, such as a premium enhancement rider 102, an accumulated value enhancement rider 104, or any other number of other riders or types of other riders. In the arrangement shown, performance enhancement rider dashboard 100 is an interactive user display, such as that presented on a computer screen, laptop, smart phone, tablet or other interactive display device. The performance enhancement rider dashboard 100 presented in FIG. 1 initiates the possible employment of premium enhancement rider 102, an accumulated value enhancement rider 104 or any other rider offered by life insurance company 14 or hereinafter contemplated. As an example of use, when policy owner 12 is interested in increasing the notional value of their life insurance policy 16 the policy owner 12 selects “yes” at the performance enhancement rider option button 106.

Thereafter, the policy owner 12 selects “yes” at button 108 to elect premium enhancement rider 102. Thereafter, the policy owner 12 selects the percentage of the premium the policy owner 12 wants to allocate toward the premium enhancement rider 102 through selection of the desired button 110. As examples, 30%, 40% and 50% are shown as predetermined options in association with button 110, however any other amount may be offered and/or selected, and as one example, a fillable field may be presented that allows the policy owner 12 to enter any numerical amount. As one example, in addition to selecting the percentage applied to premium enhancement rider 102 through button 108, the system 10 may include additional buttons that allow the policy owner 12 to select additional features of the premium enhancement rider 102 which may include the minimum return, the maximum return, the financial index that the premium enhancement rider 102 is tied to (such as S&P500, the NASDAQ, the Dow, the Russell 2000, or any other financial index), the term, or any other feature, facet or option of premium enhancement rider 102. In this way, life insurance company 14 may provide the policy owner 12 with substantial control over the terms, direction and operation of the premium enhancement rider 102 so that the policy owner 12 may achieve their financial goals through the system 10.

Similarly, the policy owner 12 selects “yes” at button 112 to elect accumulated value enhancement rider 104. Thereafter, the policy owner 12 selects the percentage of the premium the policy owner 12 wants to allocate toward the accumulated value enhancement rider 104 through selection of the desired button 114. As examples, 4.5%, 6.5% and 8.5% are shown in association with button 114, however any other amount may be offered and/or selected, and as one example, a fillable field may be presented that allows the policy owner 12 to enter any numerical amount. As one example, in addition to selecting the percentage applied accumulated value enhancement rider 104 through button 112, the system 10 may include additional buttons that allow the policy owner 12 to select additional features of the accumulated value enhancement rider 104 which may include the minimum return, the maximum return, the financial index that the accumulated value enhancement rider 104 is tied to (such as S&P500, the NASDAQ, the Dow, the Russell 2000, or any other financial index), the term, or any other feature, facet or option of accumulated value enhancement rider 104. In this way, life insurance company 14 may provide the policy owner 12 with substantial control over the terms, direction and operation of the accumulated value enhancement rider 104 so that the policy owner 12 may achieve their financial goals through the system 10.

Once the policy owner 12 makes their selections using performance enhancement rider dashboard 100, life insurance company 14 uses this information to calculate various aspects of the life insurance policy 16.

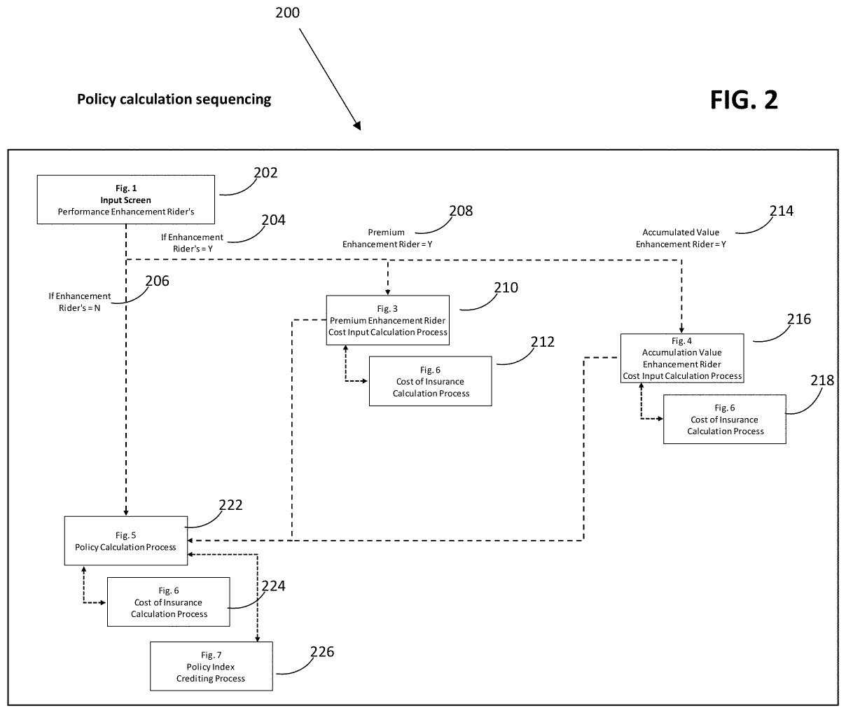

With reference to FIG. 2, once the policy owner 12 declares rider usage FIG. 2 starts the policy calculation sequencing operation 200. Because of the dynamic nature of a policy cost structure an iterative process must be employed to properly arrive at rider cost deductions. The determined rider cost factors can then be input into the policy calculation process 500. The costs associated with the policy enhancement riders 102, 104 are determined based upon the elections made on the performance enhancement dashboard 100, In one arrangement, the policy calculation sequencing operation 200 is a software system, algorithm and/or calculation.

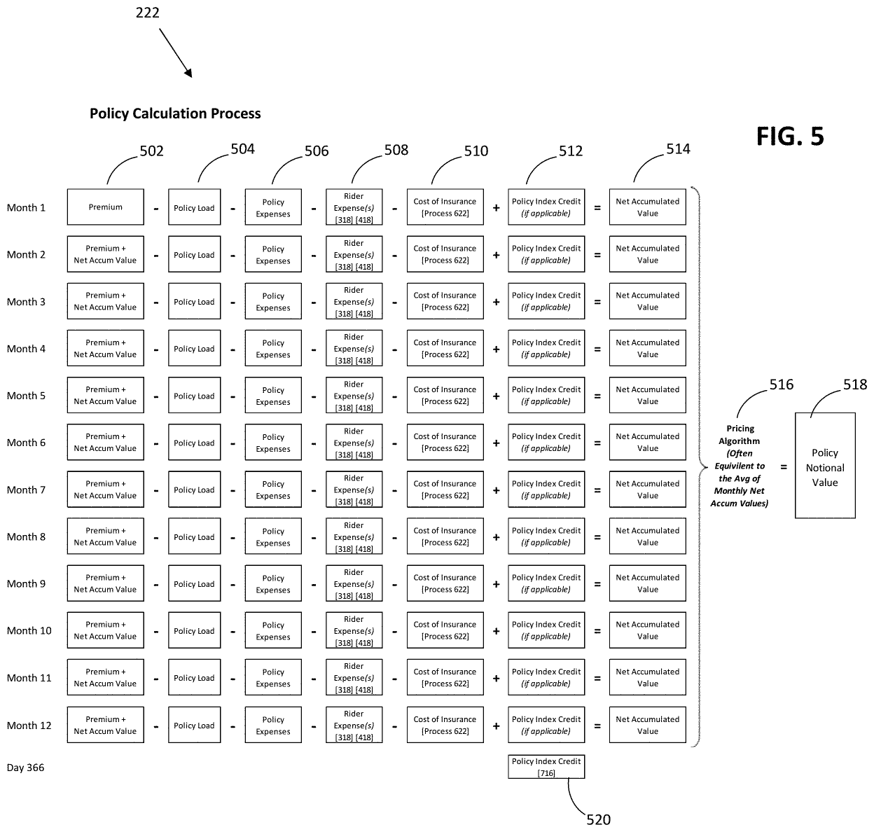

As is shown in FIG. 2, the policy calculation sequencing operation 200 begins at step 202 with consideration of the elections made at performance enhancement rider dashboard 100. At step 204, if rider enhancement was elected, the system 10 proceeds toward the calculation of the premium enhancement rider 102 and/or the accumulated value enhancement rider 104, if rider enhancement was not selected, the system 10 proceeds to policy calculation process 222 at FIG. 5.

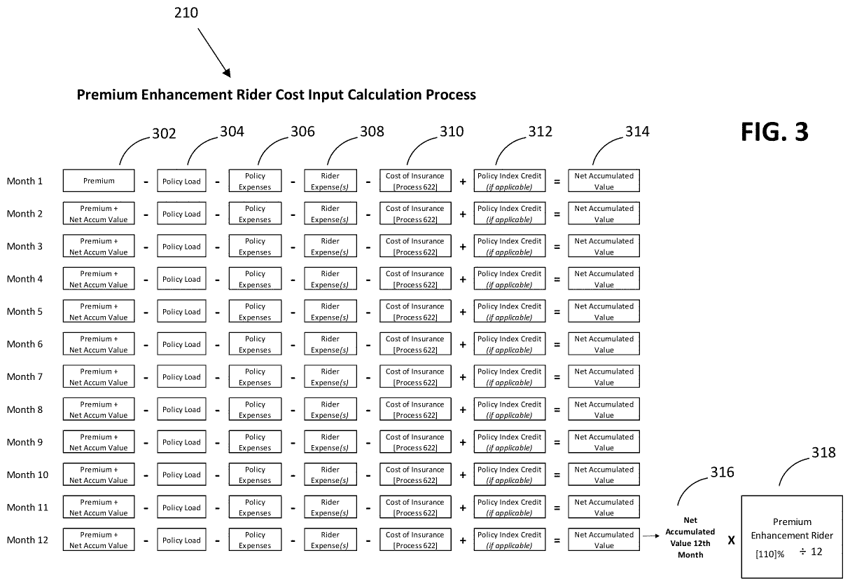

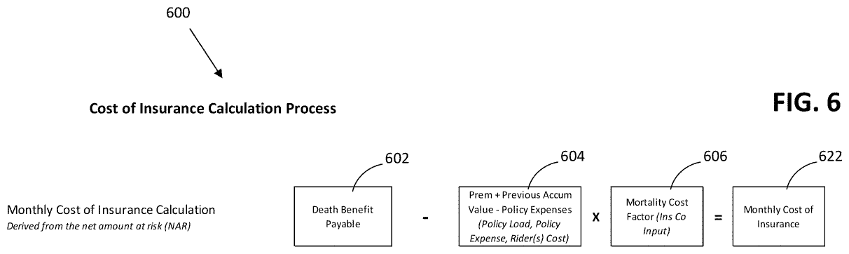

At step 208, if premium enhancement rider 102 is elected, the system 10 proceeds to the premium enhancement rider cost input calculation process 210 at FIG. 3, followed by cost of insurance calculation process 212 at FIG. 6.

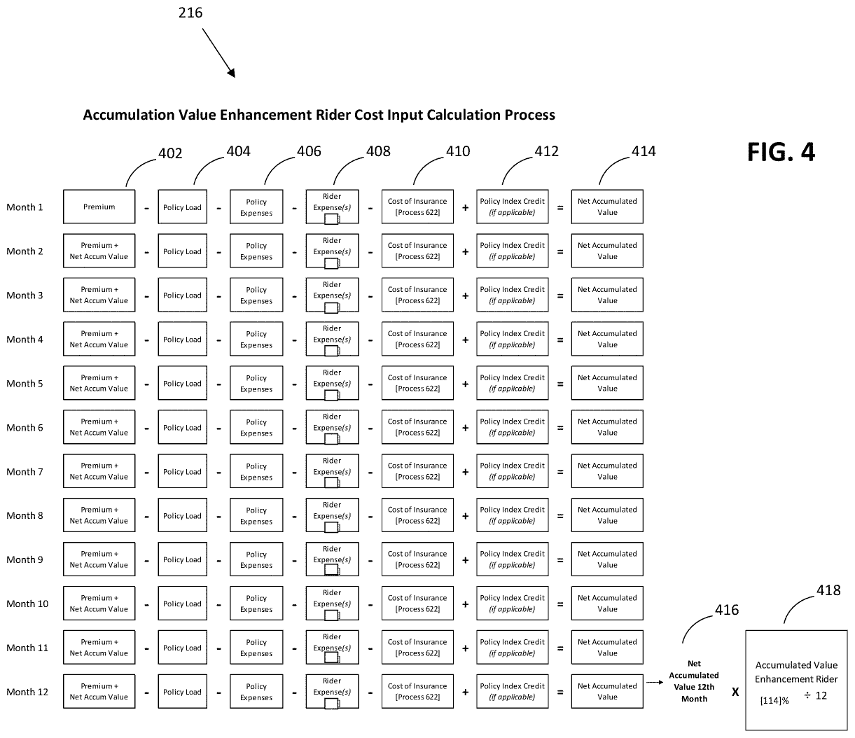

At step 214, if accumulated value enhancement rider 104 is elected, the system 10 proceeds to the accumulated value enhancement rider cost input calculation process 216 at FIG. 4, followed by cost of insurance calculation process 218 at FIG. 6.

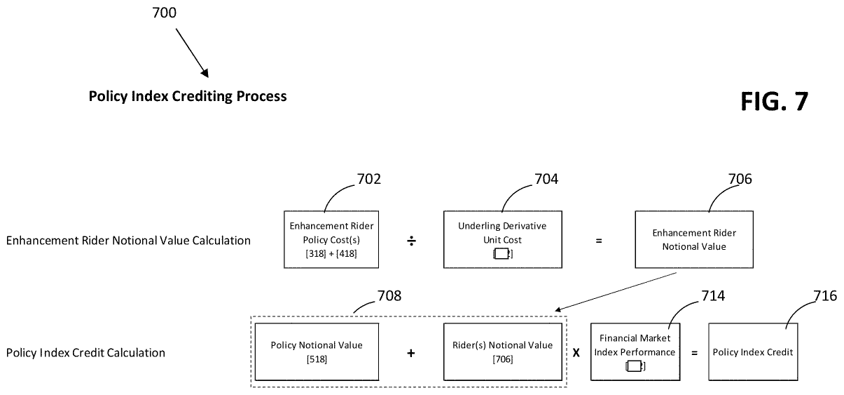

At step 222, after the performance of premium enhancement rider cost input calculation process 210 at FIG. 3, and the accumulated value enhancement rider cost input calculation process 216 at FIG. 4 the system proceeds to the cost of insurance calculation process 224 at FIG. 6 and the policy index crediting process 226 at FIG. 7.

With reference to FIG. 3, premium enhancement rider cost input calculation process 210 is used which is a calculation process used to determine the monthly cost of the Premium Based Enhancement Rider Cost 318 for the premium enhancement rider 102. If the input scenario includes the Premium Enhancement Rider 102 appropriate cost factors will be input starting in cell 508 through cell 520. Pursuant to the calculation process an iterative step process is employed to arrive at proper monthly cost of insurance 622 into cell 310. Further to complete the calculative process to arrive at the Premium Based Enhancement Rider Cost 318 the crediting process is employed, its result policy index credit 716 is employed into 312 as and when appropriate.

More specifically, the premium enhancement rider cost input calculation process 210 incorporates, by month or any other term, the premium 18 (and any net accumulated value) at 302, the policy load at 304, policy expenses at 306, rider expenses at 308, the cost of insurance (from process 622) at 310, the policy index credit at 312 to arrive at the net accumulated value 314. This result is tallied as the net accumulated value 12^{th} month at 316 which is multiplied by the premium enhancement rider percentage 110 divided by 12 months (or any other selected term).

With reference to FIG. 4, accumulated value enhancement rider cost input calculation process 216 is used which is a calculation process used to determine the monthly cost of the Accumulation Value Based Enhancement Rider Cost 418 for accumulated value enhancement rider 104. If the input scenario includes the accumulated value enhancement rider 104 appropriate cost factors will be input starting in cell 508 through cell 520. Pursuant to the calculation process an iterative step process is employed to arrive at proper monthly cost of insurance 622 into cell 410. Further to complete the calculative process to arrive at accumulated value enhancement rider cost 418 the crediting process is employed, its result policy index credit 716 is employed, into 412 as and when appropriate.

More specifically, the accumulated value enhancement rider cost input calculation process 216 incorporates, by month or any other term, the premium 18 (and any net accumulated value) at 402, the policy load at 404, policy expenses at 406, rider expenses at 408, the cost of insurance (from process 622) at 410, the policy index credit at 412 to arrive at the net accumulated value 414. This result is tallied as the net accumulated value 12^{th} month at 416 which is multiplied by the accumulated value enhancement rider percentage 114 divided by 12 months (or any other selected term).

With reference to FIG. 5, the policy calculation process 222 is used which is a calculation process used to determine the policy notional value 518. If the input scenario includes the Premium Enhancement Rider 102 and/or the accumulation value enhancement rider 104 appropriate cost factors will be input starting in cell 508 through cell 520. Pursuant to the calculation process an iterative step process is employed to arrive at proper monthly cost of insurance 622 into cell 310 and 410. Further to complete the calculative process to arrive at 318 and 418 the crediting process is employed, its result policy index credit 716 is employed, into 312 and 412 as and when appropriate.

More specifically, the policy calculation process 222 incorporates, by month or any other term, the premium 18 (and any net accumulated value) at 502, the policy load at 504, policy expenses at 506, rider expenses at 508 (from 318 and 418), the cost of insurance at 510 (from process 622), the policy index credit at 512 to arrive at the net accumulated value 516. This result is tallied at 516 as the pricing algorithm (often equivalent to the average monthly net accumulated values) which is or equals or is equivalent to the policy notional value 518 and the policy index credit is tallied at 520.

With reference to FIG. 6, the cost of insurance calculation process 600 is used which is a calculation process used to determine the monthly cost of insurance which is derived from the net amount at risk (NAR). In the arrangement shown, as one example, this includes the death benefit payable 602 minus the premium plus previous accumulated value minus policy expenses (including policy load, policy expenses, and rider costs) 604 times the mortality cost factor 606 which results in the monthly cost of insurance 622.

With reference to FIG. 7, the policy index crediting process 700 is used which is a calculation process used to determine the policy index credit (which may be based on market performance). In the arrangement shown, as one example, this includes the enhancement rider notional value calculation which includes the enhancement rider policy costs (318+418) 702 divided by the underling derivative unit cost which results in the enhancement rider notional value 706. In the arrangement shown, as one example, the policy index credit calculation is then performed at 708 by adding the policy notional value 518 and the rider(s) notional value 706 multiplied by the financial market index performance 714 resulting in the policy index credit 716.

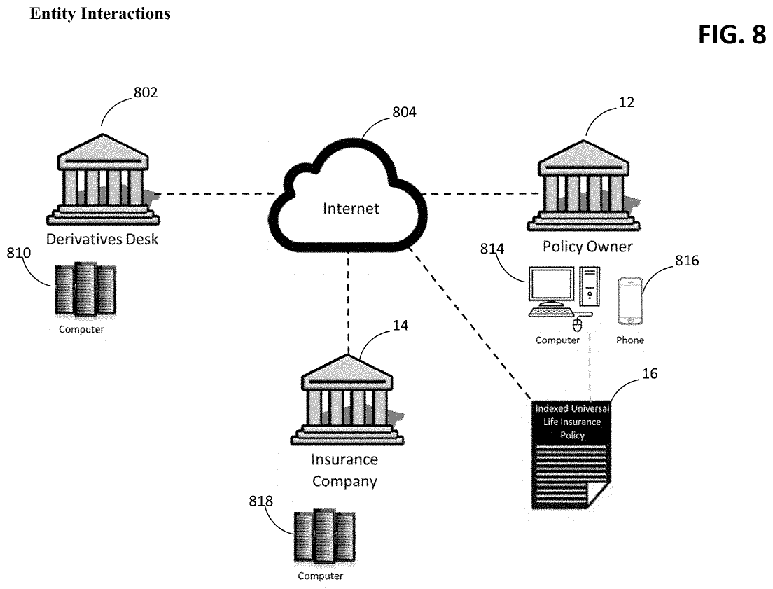

With reference to FIG. 8, a plan view of one arrangement, as one example, of the interconnected components of system 10 is presented. In the arrangement shown, as one example, policy owner 12 connects through a computer 814 or smart phone 816 or another internet enabled device through the internet 804 to life insurance company 14. Through this connection, policy owner 12 makes their elections, including the type of policy, the elections as it relates to premium enhancement rider 102, accumulated value enhancement rider 104, and the like. The life insurance company 14, using their home office system, the system 10 presented herein, their actuarial information and software and algorithms using the database of information and the processing power of computers system 818 performs the calculations described herein to price, maintain and fulfill the obligations of the life insurance policy 16. In doing so, the life insurance company 14 reaches out to the derivatives desk 802 to determine pricing for the components of the life insurance policy 16, which may be a transaction of information through the internet 804. At the culmination of this process, insurance policy 16 is provided to policy owner 12.

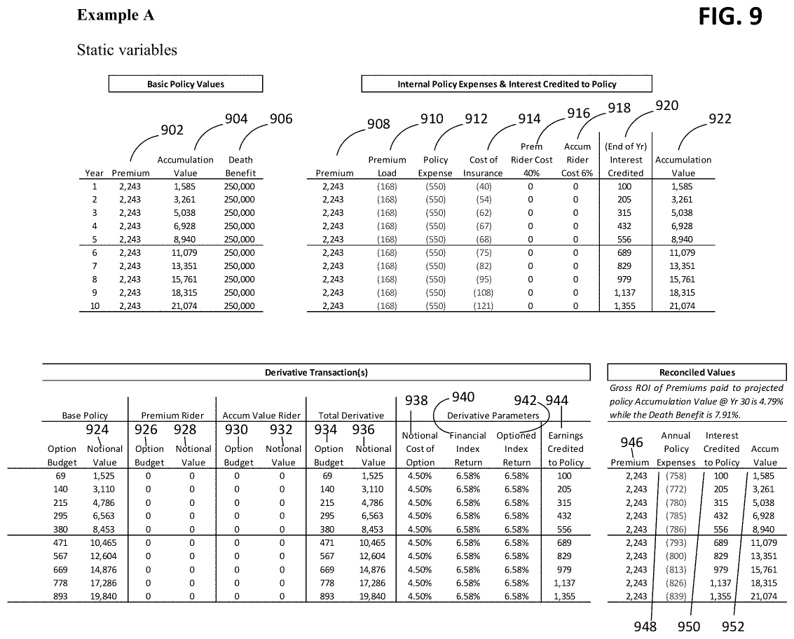

With reference to FIGS. 9-12, an example of the performance of the basic life insurance policy 16 is presented, along with the performance of the same policy with the addition of the policy enhancement riders premium enhancement rider 102, the accumulated value enhancement rider 104, and the addition of both the policy enhancement riders premium enhancement rider 102 and accumulated value enhancement rider 104, which shows the performance enhancement of the system 10 presented herein.

With reference to FIG. 9, Exhibit A demonstrates an embodiment of a of an Indexed Universal Life Insurance policy 16 without the policy enhancement riders (premium enhancement rider 102 or accumulated value enhancement rider 104). This exhibit is a close relation to illustrations used by industry to demonstrate prospective life insurance policy performance. This exhibit is based on fixed crediting and pricing assumptions. Note the 0 in columns 916 and 918.

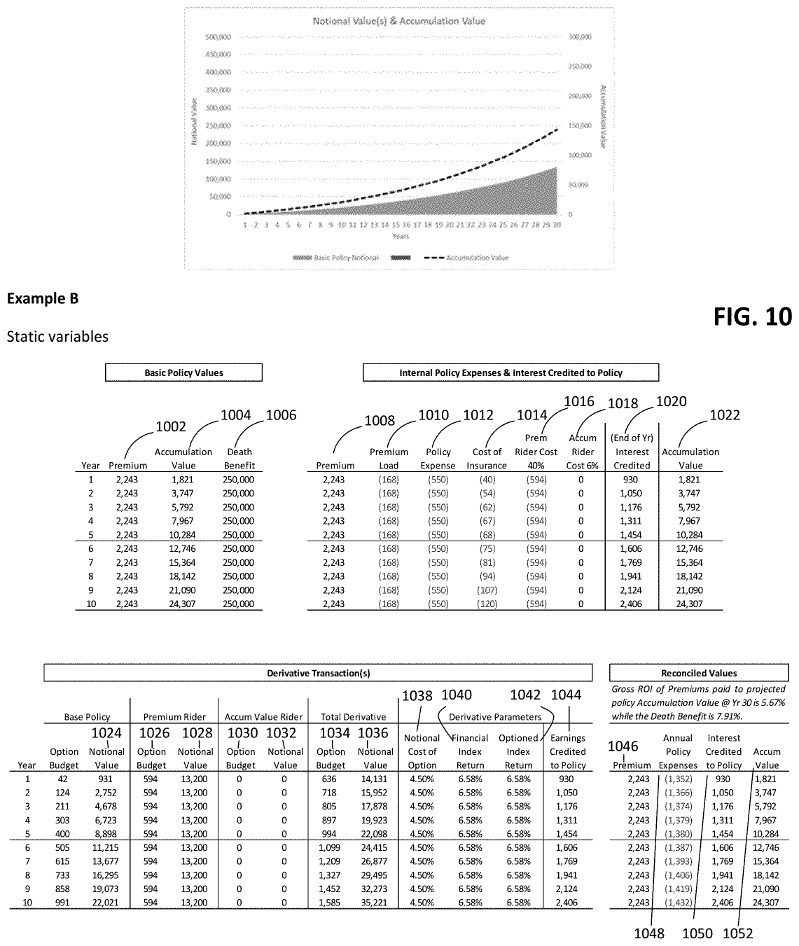

With reference to FIG. 10, Exhibit B demonstrates an embodiment of a of an Indexed Universal Life policy 16 with the inclusion of the Premium Performance Enhancement Rider 102. This exhibit is a close relation to illustrations used by industry to demonstrate prospective life insurance policy performance. This exhibit is based on fixed crediting and pricing assumptions. Note the cost in column 1016 and the 0 in column 1018.

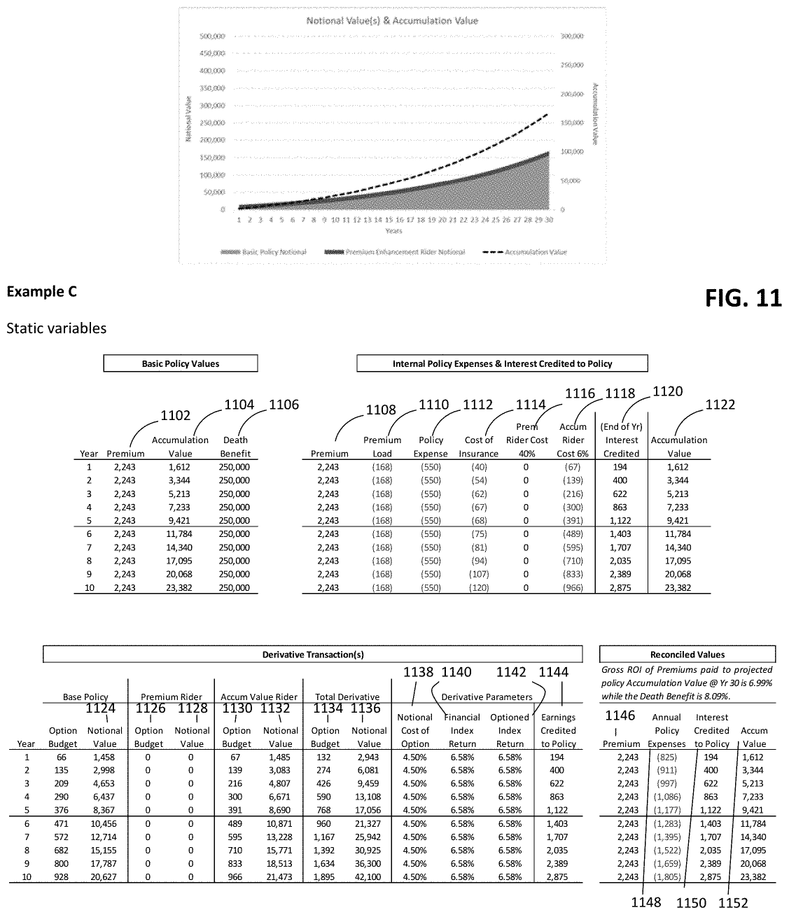

With reference to FIG. 11, Exhibit C demonstrates the embodiment of a of an Indexed Universal Life Insurance policy with the inclusion of the Accumulated Value Performance Enhancement Rider 104. This exhibit is a close relation to illustrations used by industry to demonstrate prospective policy performance. This exhibit is based on fixed crediting and pricing assumptions. Note the 0 in column 1116 and the cost in column 1118.

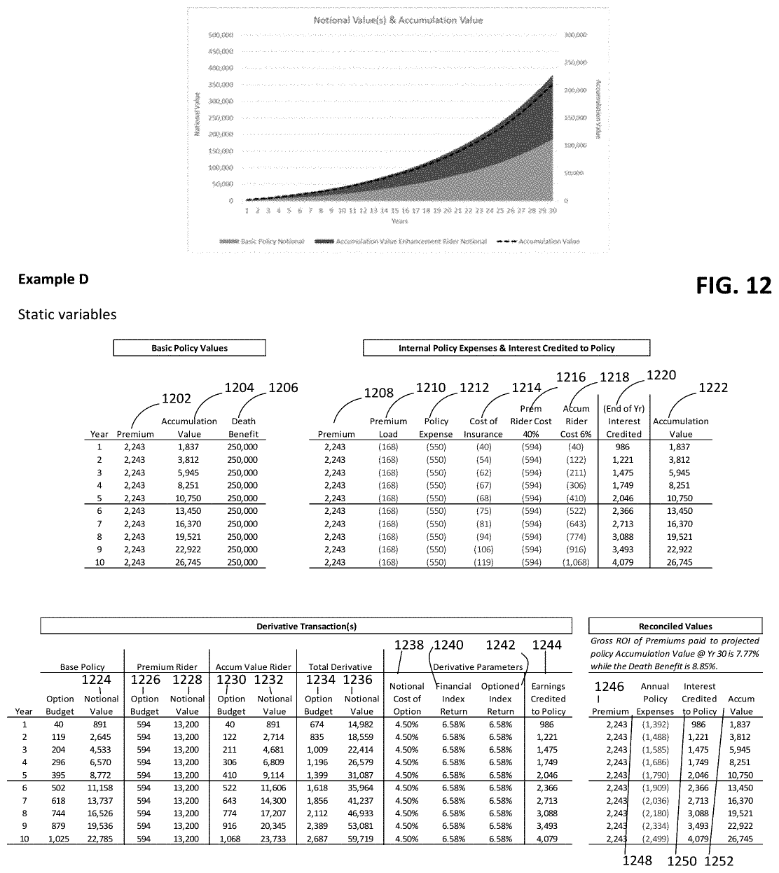

With reference to FIG. 12, Exhibit D demonstrates the embodiment of a of an Indexed Universal Life Insurance policy with the inclusion of both the Premium Performance Enhancement Rider 102 plus the Accumulated Value Performance Enhancement Rider 104. This exhibit is a close relation to illustrations used by industry to demonstrate prospective policy performance. This exhibit is based on fixed crediting and pricing assumptions. Note the cost in column 1216 and the cost in column 1218.

Comparing the results of FIG. 9, FIG. 10, FIG. 11 and FIG. 12 reveals that under this simulation, after ten years the accumulated value of the basic policy shown in FIG. 9 is $21,074. With reference to FIG. 10, the same policy with the addition of the Premium Performance Enhancement Rider 102 results in an accumulated value $24,307, which is a 15% premium over the basic policy ($24,307/$21,074=1.1534). With reference to FIG. 11, the same policy with the addition of the Accumulated Value Performance Enhancement Rider 104 results in an accumulated value $23,382, which is a 11% premium over the basic policy ($23,382/$21,074=1.1095). With reference to FIG. 12, the same policy with the addition of both the Premium Performance Enhancement Rider 102 and the Accumulated Value Performance Enhancement Rider 104 results in an accumulated value $26,745, which is a 27% premium over the basic policy ($26,745/$21,074=1.2690). As such, the implementation of the system 10 presented herein provides substantially improved performance.

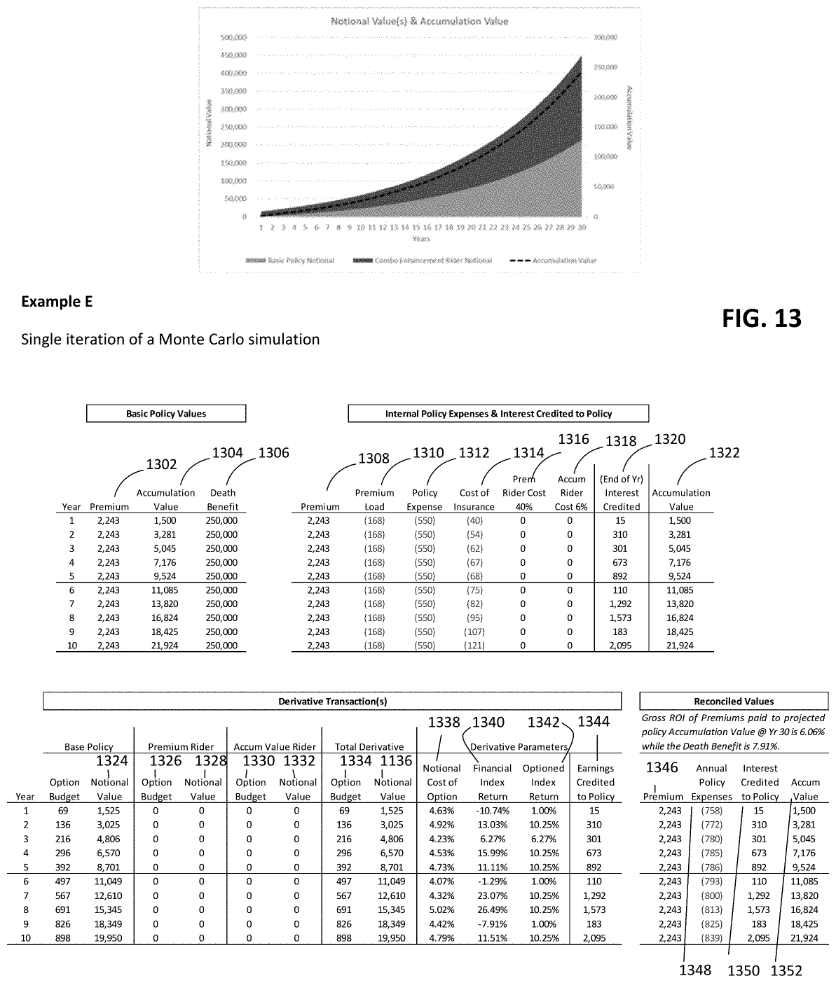

With reference to FIGS. 13-16, an example of the performance of the basic life insurance policy 16 is presented through a Monte Carlo simulation, along with the performance of the same policy with the addition of the policy enhancement riders premium enhancement rider 102, the accumulated value enhancement rider 104, and the addition of both the policy enhancement riders premium enhancement rider 102 and accumulated value enhancement rider 104, which shows the performance enhancement of the system 10 presented herein

With reference to FIG. 13 Exhibit E demonstrates the embodiment of a of an Indexed universal life insurance policy without the policy enhancement riders (premium enhancement rider 102 or accumulated value enhancement rider 104). This exhibit is a close relation to illustrations used by industry to demonstrate prospective policy performance. This exhibit is based on single iteration of a stochastic Monte Carlo simulation based on random crediting and pricing assumptions. Note the 0 in columns 1316 and 1318.

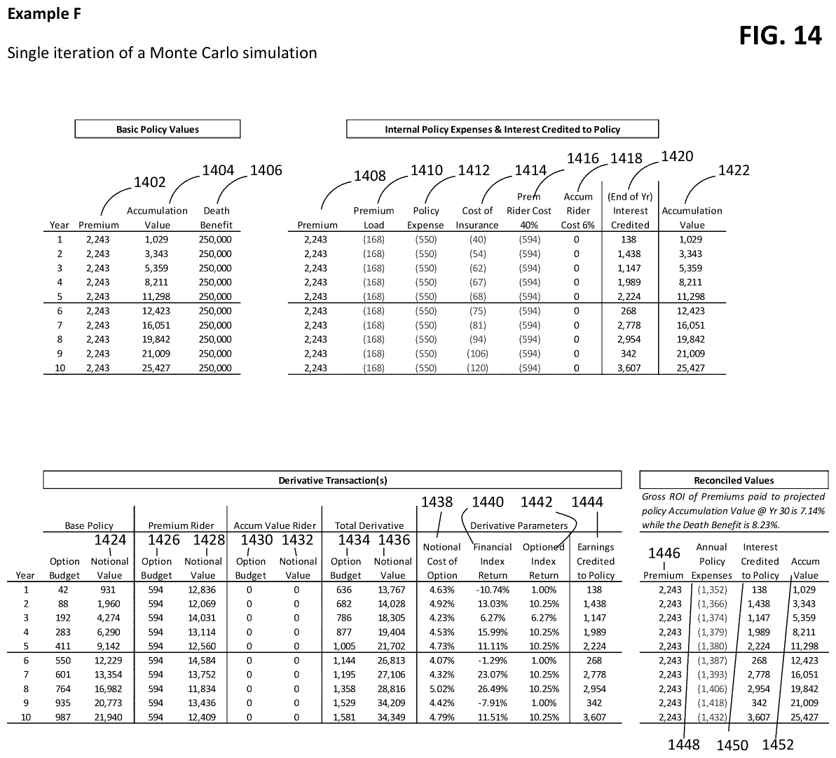

With reference to FIG. 14 Exhibit F demonstrates the embodiment of a of an Indexed universal life insurance policy with the inclusion of the Premium Performance Enhancement Rider 102. This exhibit is a close relation to illustrations used by industry to demonstrate prospective policy performance. This exhibit is based on single iteration of a stochastic Monte Carlo simulation based on random crediting and pricing assumptions. Note the cost in column 1416 and the 0 in column 1418.

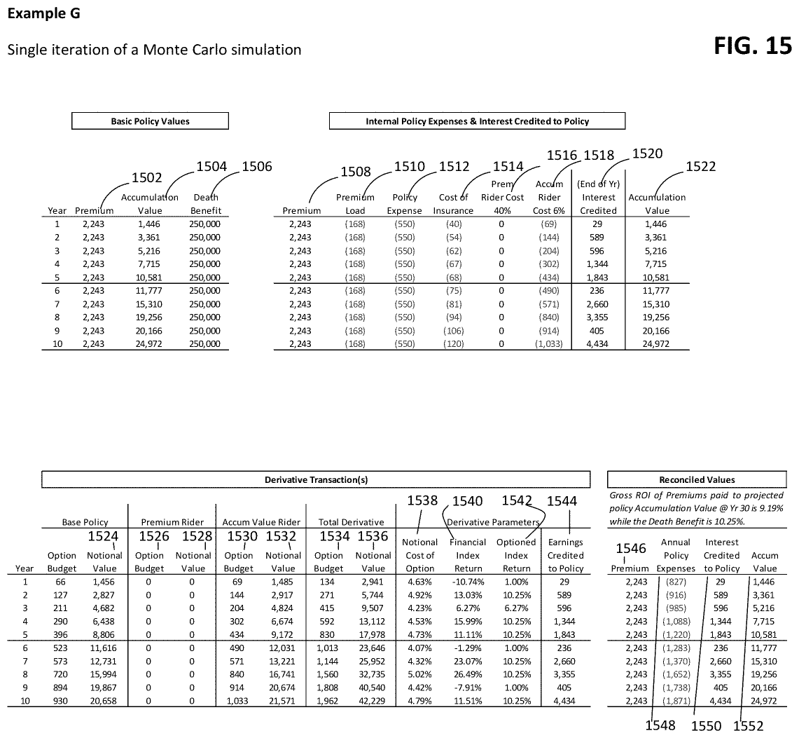

With reference to FIG. 15 Exhibit G demonstrates the embodiment of a of an Indexed universal life insurance policy with the inclusion of the Accumulated Value Performance Enhancement Rider. This exhibit is a close relation to illustrations used by industry to demonstrate prospective policy performance. This exhibit is based on single iteration of a stochastic Monte Carlo simulation based on random crediting and pricing assumptions. Note the 0 in column 1516 and the cost in column 1518.

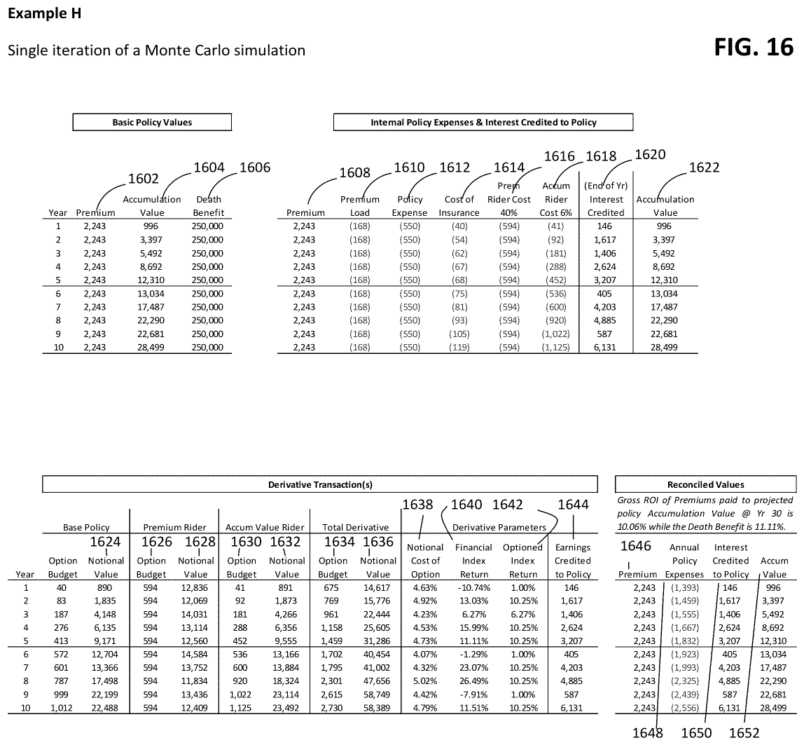

With reference to FIG. 16 Exhibit H demonstrates the embodiment of a of an Indexed universal life insurance policy with the inclusion of both the Premium Performance Enhancement Rider plus the Accumulated Value Performance Enhancement Rider. This exhibit is a close relation to illustrations used by industry to demonstrate prospective policy performance. This exhibit is based on single iteration of a stochastic Monte Carlo simulation based on random crediting and pricing assumptions. Note the cost in column 1616 and the cost in column 1618.

Comparing the results of FIG. 13, FIG. 14, FIG. 15 and FIG. 16 reveals that under this simulation, after ten years the accumulated value of the basic policy shown in FIG. 13 is $21,924. With reference to FIG. 14, the same policy with the addition of the Premium Performance Enhancement Rider 102 results in an accumulated value $25,427, which is a 16% premium over the basic policy ($25,427/$21,924=1.1597). With reference to FIG. 15, the same policy with the addition of the Accumulated Value Performance Enhancement Rider 104 results in an accumulated value $24,974, which is a 14% premium over the basic policy ($24,972/$21,924=1.1390). With reference to FIG. 16, the same policy with the addition of both the Premium Performance Enhancement Rider 102 and the Accumulated Value Performance Enhancement Rider 104 results in an accumulated value $28,499, which is a 30% premium over the basic policy ($28,499/$21,924=1.2998). As such, the implementation of the system 10 presented herein provides substantially improved performance.

Additional Elements:

In one arrangement, the life insurance policy 16 includes a cumulative net premium policy crediting rate guarantee which may apply to the basic or base policy, the premium enhancement rider 102, the accumulated value enhancement rider 104 or any combination of these policies or riders.

In one arrangement, life insurance policy 16 includes an option to opt into and opt out of insurance policy riders 102, 104 at any time or interval, such as yearly, monthly or the like, as well as make the elections discussed herein . . . ).

In one arrangement, as part of the base or basic life insurance policy 16, premium enhancement rider 102 and/or the accumulated value enhancement rider 104, there is a death benefit guarantee, which is a guaranteed amount of money paid out to the policy owner 12 in the event of death according to terms of the insurance policy 16.

Death Benefit Guarantees & Interest Guarantees:

One objective the system 10 presented herein provides is a means of taking the insurance policy 16 out of the realm of a security (which falls under the regulation of the Securities Act of 1933) and qualifies the insurance policy 16 for an exemption under Section 3(a)(8) of the Securities Act of 1933 thereby providing the insurance policy 16 with substantial tax benefits.

Market Performance:

Market performance is the performance of the indexed asset class elected by the policy owner 12 and identified in the terms elections made by the policy owner 12 and/or the terms of the life insurance policy 16. Market performance is the performance during the duration of the life insurance policy 16.

Derivatives Desk:

Once the policy owner 12 has elected the amount at risk through the purchase of the base or basic life insurance policy 16 as well as electing the amount at risk in the premium enhancement rider 102 and accumulated value enhancement rider 104, the life insurance company 14 prices or calculates the cost of the coverage through a derivatives desk. The derivatives desk may be an external entity that prices options, such as a separate company that offers options and derivatives. Alternatively, the derivatives desk may be an internal entity within life insurance company 14 that prices options. A derivative derives its value from the instrument in which it is based and includes swaps, futures and options. It is through the use of the derivatives desk that the performance and pricing of the insurance policy 16 may be performed, along with the use of algorithms described herein. Life insurance company 14 uses the derivatives desk to price the cost of the options for the life insurance policy on the micro-level, but the life insurance company 14 does not necessarily or directly buy covering options for that specific life insurance policy 16 at the time of issuance of the life insurance policy 16. Instead, the life insurance company 14 simply uses the derivatives desk to price the life insurance policy 16 based on market conditions at the time of issuance. Then, the life insurance company 14, using the aggregated funds in the general account to purchase options, derivatives and other financial instruments on the macro-level, often using the derivatives desk, to cover the promises the life insurance company 14 has made on the micro-level to its policy owners 12.

No-Lapse Guarantee Rider:

In one arrangement, a no-lapse guarantee rider is offered in association with life insurance policy 16. That is, the policy owner 12 can elect to have a no-lapse guarantee by purchasing an additional rider.

Covering Liabilities:

Once the life insurance company 14 knows the amount of potential liabilities they are facing, or said another way, the kind of guarantees they are making, based on the base life insurance policy 16 and the elected riders 102, 104, the life insurance company 14 can adjust their market exposure through the funds in their general account. Additionally they could affect an internal hedging operation. This allows them to adjust accordingly while harnessing the benefits of the large general account.

Option Periods:

Another benefit of this system is that the policy owners 12 can opt in and opt out of riders 102,104 on a periodic basis. This allows them to harness market benefits when they believe that market performance is going to be strong, and allows them to minimize financial risk when they believe the market performance will be poor.

These are only some of the countless examples of the system 10 presented herein may operate.

From the above discussion it will be appreciated that the system and method for administering a life insurance policy 10 presented improves upon the state of the art.

Specifically, the system and method for administering a life insurance policy: improves accumulated value of the life insurance policy over existing life insurance policies; allows a policy owner to opt into additional notional value exposure thorough affecting the rider(s); allows a policy owner to magnify market performance; provides some of the benefits of market performance while not exposing the returns to tax liabilities associated with investment accounts; maintains the benefits of being an insurance policy while harnessing the derivative returns of the stock market; provides the policy owner with the option to purchase a premium based enhancement rider; provides the policy owner with the option to purchase an accumulated value rider; provides the policy owner with the option to purchase a premium based enhancement rider as well as an accumulated value rider; is relatively easy for the life insurance company to administer; does not run afoul of life insurance policies, rules and laws; does not run afoul of securities policies, rules and laws; provides increased returns; provides increased options for the policy; provides increased exposure to market performance through an insurance instrument; is relatively easy for the policy owner to control; operates efficiently; complies with the spirit and scope of insurance laws; complies with the spirit and scope of securities laws; provides increased insurance diversity; provides new avenues for wealth accumulation and wealth preservation, among countless other advantages and improvements.

It will be appreciated by those skilled in the art that other various modifications could be made to the device without parting from the spirit and scope of this disclosure. All such modifications and changes fall within the scope of the claims and are intended to be covered thereby.

What is claimed:

1. An indexed universal life insurance policy, comprising:
a basic policy having a notional value;
an optional premium rider having a notional value.

2. The life insurance policy of claim 1 wherein notional value is an amount exposed to market performance.

3. An indexed universal life insurance policy, comprising:
a basic policy having a notional value;
an optional accumulated value rider having a notional value.

4. The life insurance policy of claim 3 wherein notional value is an amount exposed to market performance.

5. An indexed universal life insurance policy, comprising:
a basic policy having a notional value;
an optional premium rider having a notional value;
an optional accumulated value rider having a notional value.

6. The life insurance policy of claim 5 wherein notional value is an amount exposed to market performance.

7. A method of administering a life insurance policy, the steps comprising:
providing a life insurance policy to a policy owner by a life insurance company;
collecting a premium from the policy owner by the life insurance company;
providing a basic insurance policy to the policy owner, wherein the basic insurance policy has a notional value;
offering a performance enhancement rider to the policy owner by the life insurance company through the life insurance policy, wherein the performance enhancement rider is a premium rider;
opting into the premium rider by the policy owner deducting costs from the premium by the life insurance company for administration of the life insurance policy;
opting in to a premium rider by the policy owner;
allocating a portion of the premium, net of the costs, as an premium rider cost;
purchasing a premium rider option having a duration and terms with the insurance policy rider cost thereby establishing the notional value of the premium rider option;
determining a payout for the premium rider option at the end of the duration based on the terms and market performance;
allocating the payout for the premium rider option to an accumulated value of the life insurance policy.

8. The method of claim 7, further comprising the step of:
providing a base policy as part of the life insurance policy;
allocating a portion of the premium as a base policy option cost;
purchasing a base policy option having a duration and terms with the base policy option cost thereby establishing the notional value of the base policy option;
determining a payout for the base policy option at the end of the duration based on the terms and market performance;
allocating the payout for the base policy option to the accumulated value of the life insurance policy.

9. The method of claim 7, further comprising the step of: determining the insurance policy rider cost through a derivatives desk.

10. The method of claim 7, further comprising wherein the insurance policy rider cost is a predetermined percentage of the premium, net of the costs.

11. The method of claim 7, further comprising wherein at the end of the duration the policy owner can opt out of the insurance policy rider.

12. The method of claim 7, further comprising wherein the life insurance policy includes a death benefit guarantee.

13. The method of claim 7, further comprising wherein the insurance policy rider includes a death benefit guarantee.

14. The method of claim 7, further comprising wherein the insurance policy rider includes a no-lapse death benefit guarantee of a specified duration.

15. The method of claim 7, further comprising wherein the insurance policy rider includes a cumulative guaranteed value.

16. The method of claim 7, further comprising the step of: offering an additional no-lapse guarantee rider applicable to age one hundred and twenty one.

17. The method of claim 7, further comprising wherein the insurance policy is an indexed universal life insurance policy.

18. A method of administering a life insurance policy, the steps comprising:
providing a life insurance to the policy to a policy owner by a life insurance company for a premium;
deducting costs from the premium by the life insurance company for administration of the life insurance policy;
opting in to an accumulated value rider by the policy owner;
allocating a portion of the net accumulated value of the life insurance policy, as an accumulated value rider cost;
purchasing an accumulated value rider option having a duration and terms with the accumulated value rider cost thereby establishing the notional value of the accumulated value rider option;
determining a payout for the accumulated value rider option at the end of the duration based on the terms and market performance;
allocating the payout for the accumulated value rider option to an accumulated value of the life insurance policy.

19. The method of claim 18, further comprising the steps of:
providing a base policy as part of the life insurance policy;
allocating a portion of the premium as a base policy option cost;
purchasing a base policy option having a duration and terms with the base policy option cost thereby establishing the notional value of the base policy option;
determining a payout for the base policy option at the end of the duration based on the terms and market performance;
allocating the payout for the base policy option to the accumulated value of the life insurance policy.

20. The method of claim 18, further comprising the step of: determining the accumulated value rider cost through a derivatives desk.

21. The method of claim 18, further comprising wherein the accumulated value rider cost is a predetermined percentage of the accumulated value, net of the costs.

22. The method of claim 18, further comprising wherein at the end of the duration the policy owner can opt out of the accumulated value rider.

23. The method of claim 18, further comprising wherein the life insurance policy includes a death benefit guarantee.

24. The method of claim 18, further comprising wherein the accumulated value rider includes a death benefit guarantee.

25. The method of claim 18, further comprising wherein the accumulated value rider includes a no-lapse death benefit guarantee of a specified duration.

26. The method of claim 18, further comprising wherein the accumulated value rider includes a cumulative guaranteed value.

27. The method of claim 18, further comprising the step of: offering an additional no-lapse guarantee rider applicable to age one hundred and twenty one.

28. The method of claim 18, further comprising wherein the insurance policy is an indexed universal life insurance policy.
